(19) United States
(12) Patent Application Publication
(10) Pub. No.: US 2025/0257511 A1
(43) Pub. Date: Aug. 14, 2025

(54) ENERGY CONSUMPTION LEVELING FOR CONNECTED APPLIANCES

(71) Applicant: Haier US Appliance Solutions, Inc., Wilmington, DE (US)

(72) Inventors: Haitian Hu, Louisville, KY (US); Hairong Li, Louisville, KY (US)

(21) Appl. No.: 18/440,403

(22) Filed: Feb. 13, 2024

(51) Int. Cl. D06F 33/72; D06F 33/70; H02J 3/14

(52) U.S. Cl. CPC D06F 33/72; D06F 33/70; H02J 3/14

(57) ABSTRACT

A method for using a remote server to schedule operating cycles of an appliance includes receiving a request to perform an operating cycle of the appliance at a preferred start time, obtaining an energy consumption capacity schedule from a utility company providing power to the appliance, determining a cycle start time of the operating cycle based at least in part on the energy consumption capacity schedule and the preferred start time, and transmitting a cycle authorization for initiating the operating cycle of the appliance at the cycle start time.

### FIELD OF THE INVENTION

The present subject matter relates generally to appliances, and more particularly to connected appliances and energy leveling on utility grids.

### BACKGROUND OF THE INVENTION

Residential and commercial appliances commonly perform operating cycles that last for specified durations and consume a specific amount of power throughout the operating cycles. These operating cycles are commonly performed on-demand, i.e., the operating cycles are initiated immediately upon request of the user of the appliance. However, utility companies that provide the power to perform these cycles often experience peak energy hours when the overall power usage by all power consumers is at its highest and periods of low energy demand where the overall power usage is low. It is generally desirable to avoid excessive peaks in overall power usage, e.g., as utility companies must ramp up power production and may increase electric rates during peak energy usage times.

Conventional methods for power consumption leveling aims to motivate consumers to reduce their energy usage during peak hours by implementing time-of-use rates and energy management systems. However, this approach has limitations such as the unpredictability of power reduction during peak hours and the potential waste of dynamic opportunities on the power grid caused by unconditionally shifting appliance cycles.

Accordingly, a method for scheduling appliance operating cycles in accordance with real-time energy consumption is desired. More specifically, a system that uses cloud-based communications to level energy consumption associated with appliance operating cycles to improve grid stability, lower energy costs, and allow for the possibility of running delayed appliance cycles earlier would be particularly beneficial.

### BRIEF DESCRIPTION OF THE INVENTION

Aspects and advantages of the invention will be set forth in part in the following description, or may be apparent from the description, or may be learned through practice of the invention.

In one exemplary embodiment, a method for using a remote server to schedule operating cycles of an appliance is provided, including receiving a request to perform an operating cycle of the appliance at a preferred start time, obtaining an energy consumption capacity schedule from a utility company providing power to the appliance, determining a cycle start time of the operating cycle based at least in part on the energy consumption capacity schedule and the preferred start time, and transmitting a cycle authorization for initiating the operating cycle of the appliance at the cycle start time.

In another exemplary embodiment, a remote server is provided including a wireless communication module in operative communication with an appliance and a utility company providing power to the appliance and a processor configured to receive a request to perform an operating cycle of the appliance at a preferred start time, obtain an energy consumption capacity schedule from the utility company, determine a cycle start time of the operating cycle based at least in part on the energy consumption capacity schedule and the preferred start time, and transmit a cycle authorization for initiating the operating cycle of the appliance at the cycle start time.

In another exemplary embodiment, a method of scheduling an operating cycle of an appliance using a remote server is provided including transmitting, to the remote server, a request to perform the operating cycle of the appliance at a preferred start time, receiving a cycle authorization for initiating the operating cycle of the appliance at a cycle start time, the cycle start time being determined by the remote server based at least in part on an energy consumption capacity schedule and the preferred start time, and automatically initiating the operating cycle at the cycle start time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a schematic view of a plurality of appliances connected to a remote server through an external network according to an example embodiment of the present subject matter.

FIG. 2 provides a schematic view of a system for connecting a utility company and one or more appliances to a remote server for purposes of energy management according to an example embodiment of the present subject matter.

FIG. 3 provides a plot of an example energy demand profile on an energy grid over the course of one day according to an example embodiment of the present subject matter.

FIG. 4 illustrates a method for using a remote server to schedule operating cycles of an appliance according to an example embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “upstream” and “downstream” refer to the relative flow direction with respect to fluid flow in a fluid pathway. For example, “upstream” refers to the flow direction from which the fluid flows, and “downstream” refers to the flow direction to which the fluid flows. The terms “includes” and “including” are intended to be inclusive in a manner similar to the term “comprising.” Similarly, the term “or” is generally intended to be inclusive (i.e., “A or B” is intended to mean “A or B or both”).

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. For example, the approximating language may refer to being within a 10 percent margin.

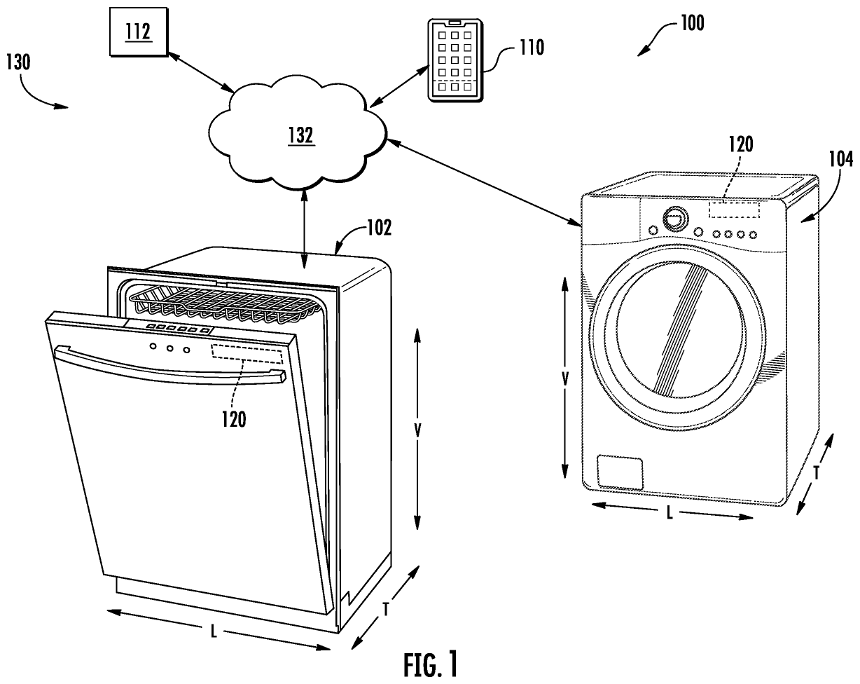

Referring now to FIG. 1, a system of appliances 100 will be described according to exemplary embodiments of the present subject matter. In general, system of appliances 100 may include any suitable number, type, and configuration of appliances, remote servers, network devices, and/or other external devices. Some of these appliances 100 may be able to communicate with each other or are otherwise interconnected. This interconnection, interlinking, and interoperability of multiple appliances and/or devices may commonly be referred to as “smart home” or “connected home” appliance interconnectivity.

FIG. 1 illustrates system of appliances 100 according to exemplary embodiments of the present subject matter. As shown, system of appliances 100 generally includes a first appliance 102 (e.g., illustrated herein as a dishwasher) and a second appliance 104 (e.g., illustrated herein as a laundry appliance such as a washer or dryer). Details regarding the operation of first appliance 102 and second appliance 104 may be understood by one having ordinary skill in the art and detailed discussion is omitted herein for brevity. However, it should be appreciated that the specific appliance types and configurations are only exemplary and are provided to facilitate discussion regarding the use and operation of an exemplary system of appliances 100. The scope of the present subject matter is not limited to the number, type, and configurations of appliances set forth herein.

For example, the system of appliances 100 may include any suitable number and type of “appliances,” such as “household appliances.” These terms are used herein to describe appliances typically used or intended for common domestic tasks, e.g., such as the appliances as illustrated in the figures. According to still other embodiments, these “appliances” may include but are not limited to a dishwasher, a microwave oven, a cooktop, an oven, a washing machine, a dryer, a refrigerator, a water heater, a water filter or purifier, an air conditioner, a space heater, and any other household appliance which performs similar functions. Moreover, although only three appliances are illustrated, various embodiments of the present subject matter may also include another number of appliances, each of which may generate and store data.

In addition, it should be appreciated that system of appliances 100 may include one or more external devices, e.g., devices that are separate from or external to the one or more appliances, and which may be configured for facilitating communications with various appliances or other devices. For example, according to exemplary embodiments of the present subject matter, the system of appliances 100 may include or be communicatively coupled with a remote user interface device 110 that may be configured to enable user interaction with some or all appliances or other devices in the system of appliances 100.

In general, remote user interface device 110 may be any suitable device separate and apart from appliances (e.g., such as first appliance 102 and second appliance 104) that is configured to provide and/or receive communications, information, data, or commands from a user. In this regard, remote user interface device 110 may be an additional user interface to the user interface panels of the various appliances within the system of appliances 100. In this regard, for example, the user interface device 110 may be a personal phone, a smartphone, a tablet, a laptop or personal computer, a wearable device, a smart home system, or another mobile or remote device. For example, the separate device may be a smartphone operable to store and run applications, also known as “apps,” and the remote user interface device 110 be provided as a smartphone app.

In addition, as will be described in more detail below, some or all of the system of appliances 100 may include or be communicatively coupled with a remote server 112 that may be in operative communication with remote user interface device 110 and/or some or all appliances within system of appliances 100. Thus, user interface device 110 and/or remote server 112 may refer to one or more devices that are not considered household appliances as used herein. In addition, devices such as a personal computer, router, network devices, and other similar devices whose primary functions are network communication and/or data processing are not considered household appliances as used herein.

As illustrated, each of first appliance 102, second appliance 104, remote user interface device 110, or any other devices or appliances in system of appliances 100 may include or be operably coupled to a controller, identified herein generally by reference numeral 120. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 120 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 120 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 120 as disclosed herein is capable of and may be operable to perform any methods, method steps, or portions of methods as disclosed herein. For example, in some embodiments, methods disclosed herein may be embodied in programming instructions stored in the memory and executed by controller 120. The memory devices may also store data that can be retrieved, manipulated, created, or stored by the one or more processors or portions of controller 120. The data can include, for instance, data to facilitate performance of methods described herein. The data can be stored locally (e.g., on controller 120) in one or more databases and/or may be split up so that the data is stored in multiple locations. In addition, or alternatively, the one or more database(s) can be connected to controller 120 through any suitable communication module, communication lines, or network(s).

Referring still to FIG. 1, a schematic diagram of an external communication system 130 will be described according to an exemplary embodiment of the present subject matter. In general, external communication system 130 is configured for permitting interaction, data transfer, and other communications between and among first appliance 102, second appliance 104, remote user interface device 110, remote server 112, other appliances within system of appliances 100, and/or one or more external devices. For example, this communication may be used to provide and receive operating parameters, cycle settings, user instructions or notifications, performance characteristics, user preferences, or any other suitable information for improved performance of one or more appliances within system of appliances 100. In addition, it should be appreciated that external communication system 130 may be used to transfer data or other information to improve performance of one or more external devices or appliances and/or improve user interaction with such devices.

In addition, remote server 112 may be in communication with an appliance and/or remote user interface device 110 through a network 132. In this regard, for example, remote server 112 may be a cloud-based server 112, and is thus located at a distant location, such as in a separate state, country, etc. According to an exemplary embodiment, remote user interface device 110 may communicate with a remote server 112 over network 132, such as the Internet, to transmit/receive data or information, provide user inputs, receive user notifications or instructions, interact with or control the appliance, etc. In addition, remote user interface device 110 and remote server 112 may communicate with the appliance to communicate similar information.

In general, communication between an appliance, remote user interface device 110, remote server 112, and/or other user devices or appliances may be carried using any type of wired or wireless connection and using any suitable type of communication network, non-limiting examples of which are provided below. For example, remote user interface device 110 may be in direct or indirect communication with the appliance through any suitable wired or wireless communication connections or interfaces, such as network 132. For example, network 132 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 130 is described herein according to an exemplary embodiment of the present subject matter. However, it should be appreciated that the exemplary functions and configurations of external communication system 130 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

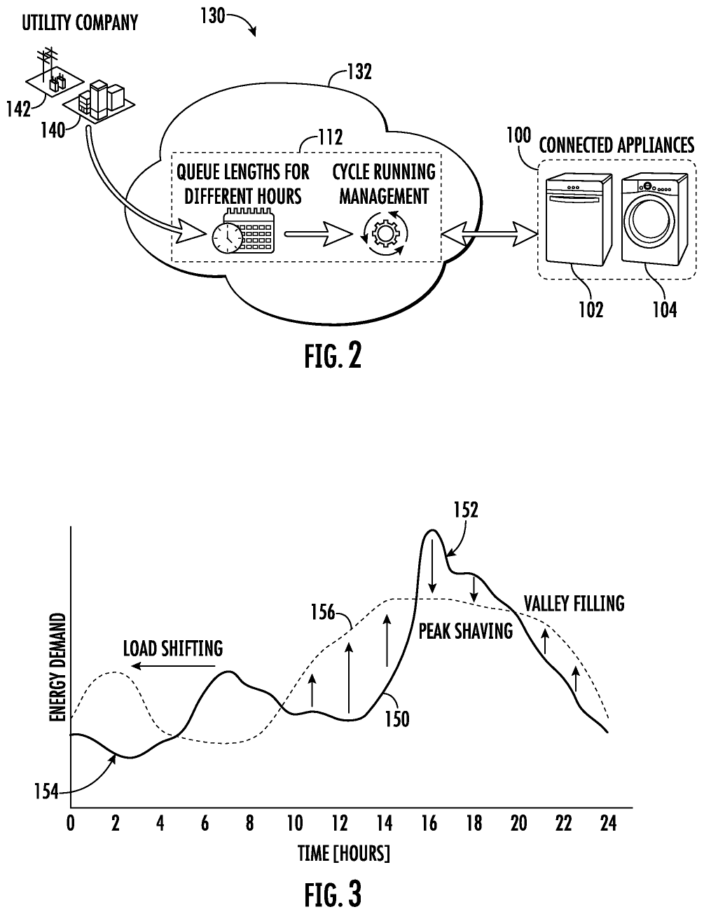

Referring now also to FIG. 2, a schematic view of a system for connecting a utility company 140 and one or more appliances 102, 104 to a remote server 112 for purposes of energy management according to an example embodiment of the present subject matter will be described. In this regard, utility company 140 may generally be any supplier of electric energy to consumers, e.g., such as owners of first appliance 102, second appliance 104, and/or any other appliances connected to an electrical grid (e.g., identified generally by reference numeral 142). Electrical grid 142 is the system of power supply lines, transformers, and other devices that transmit power to various locations that are connected to electrical grid 142 and which pay for electrical power.

As explained briefly above, utility company 140 may charge users of energy in accordance with supply and demand, e.g., where peak energy usage costs more than off-peak energy usage. For example, referring now also to FIG. 3, an exemplary energy demand profile (e.g., indicated by solid line 150) requested from electrical grid 142 will be described for an exemplary 24-hour period. For example, electrical energy demand 150 indicates the consumer demand, or the preferred electrical consumption within a particular region where utility company 140 supplies electrical power. As shown, there are periods of peak energy usage (e.g., identified generally by reference numeral 152) and periods of off-peak energy usage (e.g., identified generally by reference numeral 154).

For example, between the hours of 2 PM and 7 PM, user demand for energy is typically highest, resulting in a peak 152 in energy demand 150. By contrast, between the hours of 1 AM and 5 AM, user demand for energy is typically lowest, resulting in an off-peak period 154. Notably, in order to facilitate a stable power supply and reduce energy costs, utility company 140 may charge less for energy consumed during off-peak period 154 and more for energy consumed during peak period 152. Accordingly, aspects of the present subject matter are generally directed to methods of dynamically adjusting the energy usage by appliances. In this manner, load shifting may occur whereby increases in energy demand 150 may be shifted toward off-peak periods 154. In addition, energy demand during peak period 152 may be shifted to fill with valleys in energy demand 150, thereby resulting in a more uniform and stable energy demand profile. For example, implementing the methods described herein, the adjusted energy supply line may be indicated by reference numeral 156 in FIG. 3. Achieving this adjusted energy supply 156 may minimize the burden on utility company 140 and result in reduced costs to the energy consumers.

Now that the construction of system of appliances 100 and external communication system 130 have been presented according to exemplary embodiments, an exemplary method 200 of scheduling operating cycles of appliances using a remote server will be described. Although the discussion below refers to the exemplary method 200 of using a remote server to operate first appliance 102, one skilled in the art will appreciate that the exemplary method 200 is applicable to any other suitable number, type, and configuration of appliances. In exemplary embodiments, the various method steps as disclosed herein may be performed by the wireless control module, remote server 112, one or more controllers (e.g., such as controllers 120) or by a separate, dedicated controller that may be located locally on one or more of the appliances, remotely on a remote server, etc.

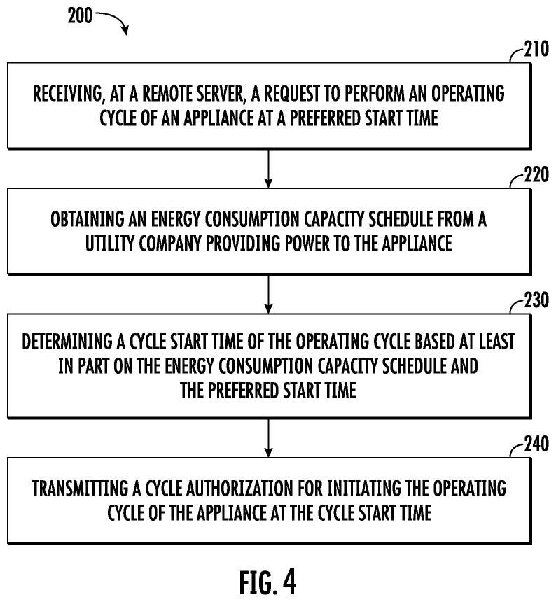

Specifically, as shown in FIG. 4, method 200 includes, at step 210, receiving, at a remote server, a request to perform an operating cycle of an appliance at a preferred start time. In this regard, first appliance 102 and second appliance 104 commonly perform a sequence of operations referred to generally herein as “operating cycles.” These operating cycles commonly have a predetermined operating duration and a predetermined energy consumption. As explained in more detail below, method 200 may generally be directed to methods for receiving a request for performing such operating cycles and scheduling such operating cycles such that energy costs are reduced.

Step 220 may generally include obtaining an energy consumption capacity schedule from a utility company providing power to the appliance. In this regard, utility company 140 may periodically or continuously update remote server 112 with the latest energy consumption capacity schedule. As used herein, the “energy consumption capacity schedule” is generally intended to refer to the actual and/or anticipated energy consumption by all users within a region serviced by utility company 140. By providing remote server 112 with this information in real-time, remote server 112 may make informed decisions on how to allocate operating cycles and energy consumption among a system of appliances.

Notably, the energy consumption capacity schedule received from the utility company 140 may be specific to the region where the requesting appliance is located. In this regard, electrical grid 142 may be broken down into a plurality of subset regions, each of which is manipulated and controlled independently by utility company 140. According to such an embodiment, the appliance requesting to perform an operating cycle may also transmit to remote server 112 an appliance region where the appliance is located. Remote server 112 may then determine that the appliance region is within a target region on a utility grid and the energy consumption capacity schedule that is retrieved may be associated with that target region.

Step 230 may generally include determining a cycle start time of the operating cycles based at least in part on the energy consumption capacity schedule and the preferred start time. In this regard, the cycle start time may be adjusted relative to the preferred start time based on the energy consumption capacity schedule to achieve the benefits described herein. For example, the energy consumption capacity schedule may limit energy consumption during peak energy consumption times (e.g., peak demand periods 152) and may prioritize energy consumption during off-peak energy consumption times (e.g., off-peak demand periods 154).

According to an example embodiment, the energy consumption capacity schedule may include an energy priority queue for a plurality of predetermined time periods. For example, the energy consumption capacity schedule may break a 24-hour period into a plurality of discrete time periods and may specify how much energy may be consumed or how many operating cycles may be performed within each specific time period of the plurality of time periods (e.g., referred to herein as the energy priority queue or cycle queue capacity). For example, the predetermined time periods may be between about 1 minute and 12 hours, between about 10 minutes and 6 hours, between about 30 minutes and 3 hours, or about 1 hour.

Notably, as discussed above, each appliance may include various operating cycles and have various operating durations and approximated energy consumption profiles. It should be appreciated that step 230 of determining the cycle start time may account for these factors in assessing whether the energy consumption capacity schedule allows for the performance of the operating cycle. In other words, operating cycles that have very low power consumption will take up less of the energy capacity and may more likely be fit into a particular time period for performing the operating cycle. By contrast, operating cycles that consume a lot of power may be deferred until a lower demand period is reached.

In general, a request to perform an operating cycle may be an instantaneous request, meaning a user wishes to perform an operating cycle immediately or as soon as possible. Alternatively, the request for an operating cycle may be a scheduled request, meaning a user wishes to schedule the performance of the operating cycle at a specific time in the future. According to example embodiments, step 230 of determining the cycle start time may vary depending on whether the request to perform the operating cycle is instantaneous or scheduled. Each of these possibilities will be described below in more detail.

In the case of an instantaneous operating cycle request, step 230 of determining the cycle start time may determine that an energy priority queue (e.g., the number of cycles that may be performed within the requested time period). If a first time period including the preferred start time is full, step 230 may include deferring the cycle start time to a second, subsequent time period where the energy priority queue is not full. For example, if a user requests the initiation of an operating cycle at 6 PM, step 230 may include assessing whether the number of cycles already approved for performance during the 6 PM to 7 PM hour exceeds a predetermined threshold. If the number of cycles exceeds that threshold (e.g., the queue is full), step 230 may include determining whether the queue associated with the 7 PM to 8 PM hour is full. If it is not full, the performance of the operating cycle may be scheduled for the 7 PM to 8 PM hour. By contrast, if the energy priority queue for that time period is full, step 230 may include investigating the next hour, and this process may be repeated until the operating cycle is scheduled and the cycle start time is determined.

In the case of a scheduled operating cycle request, the preferred start time may be in the future. Accordingly, all cycle requests received for that future time period may be assessed together to determine whether they may fit within the energy consumption capacity schedule. Notably, the cycle start time for the scheduled operating cycle request may be moved forward in time or backward in time. For example, if at 1 PM, a user requests the performance of an operating cycle at 5 PM, the cycle start time may be shifted up one hour to 4 PM or may be shifted back three hours to 8 PM depending on the energy demand 150. According to example embodiments, in such a situation, a user may be provided with a choice as to whether they would like to shift their cycle start time up or back.

It should be appreciated that according to example embodiments, these requests may be prioritized based on the time of the request. In this regard, for example, if a first appliance makes a request to perform an operating cycle and a second appliance makes a subsequent request to perform an operating cycle, the request made by the first appliance may receive priority over the request made by the second appliance. In this regard, the further out the operating cycle requests are scheduled, the more likely a user will be able to fit within the energy consumption capacity schedule without being bumped to a different time period for performing the operating cycle.

Step 240 may generally include transmitting a cycle authorization for initiation of the operating cycle of the appliance at the cycle start time. In this regard, once remote server 112 has received all information associated with the appliance request (e.g., such as appliance location, preferred start time, cycle duration, energy consumption, etc.) and has received from utility company 140 the energy consumption capacity schedule (e.g., along with target regions, energy cycle queues, etc.), remote server 112 may determine the cycle start time and communicate that cycles start time to the requesting appliance. Accordingly, the appliance that is requesting to perform an operating cycle may receive the cycle start time and may automatically initiate the performance of the operating cycle at the cycle start time. As explained above, this cycle start time may be an instantaneous approval to perform the cycle immediately or may be an approval to perform the operating cycle at some time in the future.

FIG. 4 depicts an exemplary control method having steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure. Moreover, although aspects of these methods are explained using first appliance 102 and remote server 112 as an example, it should be appreciated that these methods may be applied to any suitable appliance and utility grid.

As explained herein, aspects of the present subject matter are generally directed to an in-cloud system that regulates the power usage of a specific area by controlling the number of cycles performed by connected appliances during different hours. The utility company may use a dynamic approach to determine the length of the priority queue, that is, the number of appliance cycles that can be run, for each hour of the day in a specific area. The information may be constantly synchronized to the cloud, allowing for accommodative changes in grid demand. Appliance cycles may be allocated to hourly priority queues using two methods. The first involves direct communication between the user and appliance, where the appliance sends a “Request to Run” message to the cloud upon starting a cycle. If space is available in the corresponding hour's priority queue, the cycle may be added to the queue and starts immediately. If the queue is full, the cycle may be added to the next available hour's queue with open spots. The second approach involves scheduling cycles in advance through the appliance's UI or corresponding app, with the cycle assigned to the target hour. If there is no space available in the queue for that hour, the cycle may be assigned to the nearest hour's queue with an available spot.

This approach may address shortcomings in conventional/existing power usage leveling methods, such as inconvenience to consumers, lack of control and visibility over the power grid, and a need for manual intervention. The dynamic power leveling system described in this disclosure eliminates these shortcomings and provides a more efficient, intelligent, and automated solution for managing power usage during peak hours for different areas. This disclosure proposes a unique method of regulating power usage during peak hours by using prioritization and dynamic queue lengths. It is an efficient and intelligent system that takes advantage of cloud computing technology to provide real-time synchronized information to the connected appliances in different areas. This can help to optimize power distribution and can be beneficial for utility companies as well as consumers, resulting in a more stable and balanced power grid.

This disclosure introduces a dynamic cycle running management system that enables the option of running appliance cycles earlier. This is achieved by either directly adding the cycle to a queue or waiting availability in the queue. This approach optimizes the use of available power during peak hours, allowing for dynamic adjustments to accommodate any unexpected changes in grid demand & consumer real-time needs. It is possible to assign varying lengths of priority queue for the same hour to consumers in different areas.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for using a remote server to schedule operating cycles of an appliance, the method comprising:
receiving a request to perform an operating cycle of the appliance at a preferred start time;
obtaining an energy consumption capacity schedule from a utility company providing power to the appliance;
determining a cycle start time of the operating cycle based at least in part on the energy consumption capacity schedule and the preferred start time; and
transmitting a cycle authorization for initiating the operating cycle of the appliance at the cycle start time.

2. The method of claim 1, wherein the energy consumption capacity schedule comprises an energy priority queue for a plurality of predetermined time periods.

3. The method of claim 2, wherein determining the cycle start time of the operating cycle based at least in part on the energy consumption capacity schedule comprises:
determining that the energy priority queue for a first time period including the preferred start time is full; and
deferring the cycle start time to a second time period where the energy priority queue is not full.

4. The method of claim 1, wherein the operating cycle has an associated operating duration and an associated energy consumption, and wherein determining the cycle start time of the operating cycle is based on at least one of the associated operating duration or the associated energy consumption.

5. The method of claim 1, wherein the energy consumption capacity schedule is uploaded to the remote server in real time based on actual energy consumption from the utility company.

6. The method of claim 1, wherein the energy consumption capacity schedule limits energy consumption during peak energy consumption times.

7. The method of claim 1, wherein the energy consumption capacity schedule prioritizes energy consumption during off-peak energy consumption times.

8. The method of claim 1, wherein the preferred start time is in the future and determining the cycle start time comprises moving the cycle start time up relative to the preferred start time.

9. The method of claim 1, wherein the energy consumption capacity schedule comprises a cycle queue capacity that specifies a number of operating cycles that may be performed within a predetermined time period.

10. The method of claim 9, wherein the predetermined time period is between about 1 minute and 12 hours.

11. The method of claim 9, wherein the predetermined time period is 1 hour.

12. The method of claim 1, wherein obtaining the energy consumption capacity schedule from the utility company comprises:
receiving an appliance region of the appliance requesting to perform the operating cycle;
determining that the appliance region is within a target region on a utility grid; and
obtaining the energy consumption schedule capacity that is associated with the target region.

13. The method of claim 1, wherein the appliance is a first appliance, the method further comprising:
receiving a request to perform an operating cycle of a second appliance at a preferred start time, wherein the request to perform the operating cycle of the second appliance is received after the request to perform the operating cycle of the first appliance; and
determining a cycle start time of the operating cycle of the second appliance based at least in part on the energy consumption capacity schedule and the preferred start time, wherein the request to perform the operating cycle of the first appliance receives priority over the request to perform the operating cycle of the second appliance.

14. The method of claim 1, wherein the appliance is one of a washing machine appliance, a dryer appliance, or a dishwasher appliance.

15. A remote server comprising:
a wireless communication module in operative communication with an appliance and a utility company providing power to the appliance; and
a processor configured to:
receive a request to perform an operating cycle of the appliance at a preferred start time;
obtain an energy consumption capacity schedule from the utility company;
determine a cycle start time of the operating cycle based at least in part on the energy consumption capacity schedule and the preferred start time; and
transmit a cycle authorization for initiating the operating cycle of the appliance at the cycle start time.

16. The remote server of claim 15, wherein the energy consumption capacity schedule is uploaded to the remote server in real time based on actual energy consumption from the utility company.

17. The remote server of claim 15, wherein obtaining the energy consumption capacity schedule from the utility company comprises:
receiving an appliance region of the appliance requesting to perform the operating cycle;
determining that the appliance region is within a target region on a utility grid; and
obtaining the energy consumption schedule capacity that is associated with the target region.

18. A method of scheduling an operating cycle of an appliance using a remote server, the method comprising:
transmitting, to the remote server, a request to perform the operating cycle of the appliance at a preferred start time;
receiving a cycle authorization for initiating the operating cycle of the appliance at a cycle start time, the cycle start time being determined by the remote server based at least in part on an energy consumption capacity schedule and the preferred start time; and
automatically initiating the operating cycle at the cycle start time.

19. The method of claim 18, wherein the energy consumption capacity schedule limits energy consumption during peak energy consumption times and prioritizes energy consumption during off-peak energy consumption times.

20. The method of claim 18, further comprising:
transmitting an appliance region of the appliance, wherein the energy consumption capacity schedule is associated with the appliance region.
